(19) United States
(12) Patent Application Publication
(10) Pub. No.: US 2023/0111537 A1
(43) Pub. Date: Apr. 13, 2023

(54) AUTO-DETECTION AND RESOLUTION OF SIMILAR NETWORK MISCONFIGURATION

(71) Applicant: Hewlett Packard Enterprise Development LP, Houston, TX (US)

(72) Inventors: Shaun Wackerly, Lincoln, CA (US); Charles F. Clark, Roseville, CA (US); Jesse T. Viola, Rocklin, CA (US)

(21) Appl. No.: 17/499,771

(22) Filed: Oct. 12, 2021

(51) Int. Cl. H04L 12/24; G06K 9/62

(52) U.S. Cl. CPC H04L 41/0816; H04L 41/0853; H04L 41/0859; H04L 41/0883; G06K 9/6256

(57) ABSTRACT

The system determines a syntax for each line in a switch configuration file. The system creates, based on the syntax, one or more groups of line specifications, wherein each line specification in a group includes matching terms or values specified by a user. The system generates and deploys a new configuration to a first device. The system obtains one or more changed lines by determining a difference between a pre-deployment state and a post-deployment state. The system identifies, based on the created groups of line specifications and a set of criteria, other devices to which to deploy the new configuration. A user selects a device of the identified other devices to which to deploy the new configuration. The system deploys the new configuration to the selected device and validates the deployed new configuration. The system displays a second list which indicates whether the deployed new configuration is successfully validated.

### BACKGROUND

### Field

This disclosure is generally related to the field of data management. More specifically, this disclosure is related to a method and system for facilitating auto-detection and resolution of similar network misconfiguration.

### BRIEF DESCRIPTION OF THE FIGURES

FIG. 1 illustrates a diagram with entities and communications which facilitate auto-detection and resolution of similar network misconfiguration, in accordance with an aspect of the present application.

FIG. 2A illustrates a configuration grammar for an entry in a configuration file and a hierarchical context, in accordance with an aspect of the present application.

FIG. 2B illustrates a set of valid commands which may appear within an interface context, in accordance with an aspect of the present application.

FIG. 2C illustrates two linespecs which refer to the same logical configuration, in accordance with an aspect of the present application.

FIG. 3 illustrates a linespec group for port-access security violations and a corresponding definition, in accordance with an aspect of the present application.

FIG. 4A illustrates linespecs, corresponding terms, and a corresponding matrix, in accordance with an aspect of the present application.

FIG. 4B illustrates linespecs and a matrix which illustrates the distinction between the linespecs in FIG. 4B and the linespecs in FIG. 4A, in accordance with an aspect of the present application.

FIG. 5A presents a flowchart illustrating a method which facilitates auto-detection and resolution of similar network misconfiguration, in accordance with an aspect of the present application.

FIG. 5B presents a flowchart illustrating a method which facilitates auto-detection and resolution of similar network misconfiguration, in accordance with an aspect of the present application.

FIG. 5C presents a flowchart illustrating a method which facilitates auto-detection and resolution of similar network misconfiguration, in accordance with an aspect of the present application.

FIG. 6 illustrates a computer system which facilitates auto-detection and resolution of similar network misconfiguration, in accordance with an aspect of the present application.

FIG. 7 illustrates an apparatus which facilitates auto-detection and resolution of similar network misconfiguration, in accordance with an aspect of the present application.

In the figures, like reference numerals refer to the same figure elements.

### DETAILED DESCRIPTION

The following description is presented to enable any person skilled in the art to make and use the aspects and examples, and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown, but are to be accorded the widest scope consistent with the principles and features disclosed herein.

A network administrator may deploy a configuration change with limited scope to verify that the functional change matches their expectation. The configuration change may be based upon patterns and structures. Upon confirming the deployment of the configuration change, the network administrator may deploy the configuration change throughout the system to maintain consistency. Current solutions for deploying and validating the deployment of a configuration change to a managed network may involve relying on human memory of where changes have been deployed and may still need to be deployed. Current solutions may also involve text-based searching, e.g., through archived network configuration files, to determine where to deploy and apply the changes.

The described aspects of the present application provide a system which can reduce the amount of manual work required by a network administrator in order to properly deploy a configuration change to the managed network. Aspects of the described system can facilitate auto-detection and resolution of similar network misconfiguration by analyzing the network state and configuration to identify where a previously applied change should be replicated. The system can determine changes which should apply, even if the configuration does not match or if the line types are different. A “line specification” (abbreviated in this disclosure as “linespec”) can correlate to a specific command variant in a configuration file, including ordering of terms and keywords with specific types.

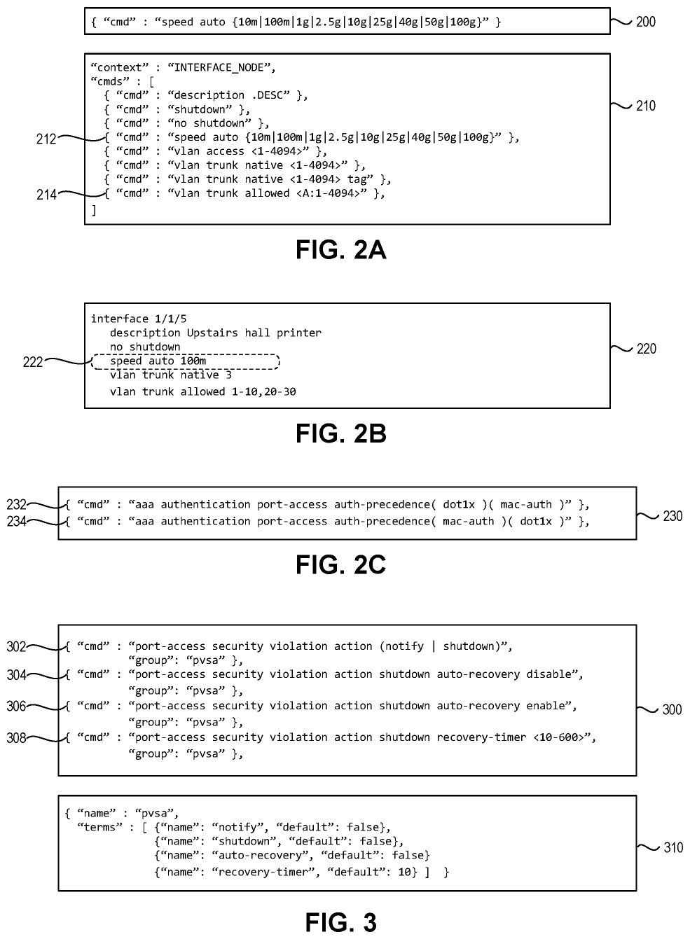

The described aspects can use a manual or automatic grouping of linespecs. Each linespec group can include a set of linespecs where each member of the group either includes the same terms/values that the user can specify or where each linespec defines default values for the terms/values that are not explicitly stated. Linespecs and linespec groups are described below in relation to FIGS. 2A, 2B, 2C, and 3.

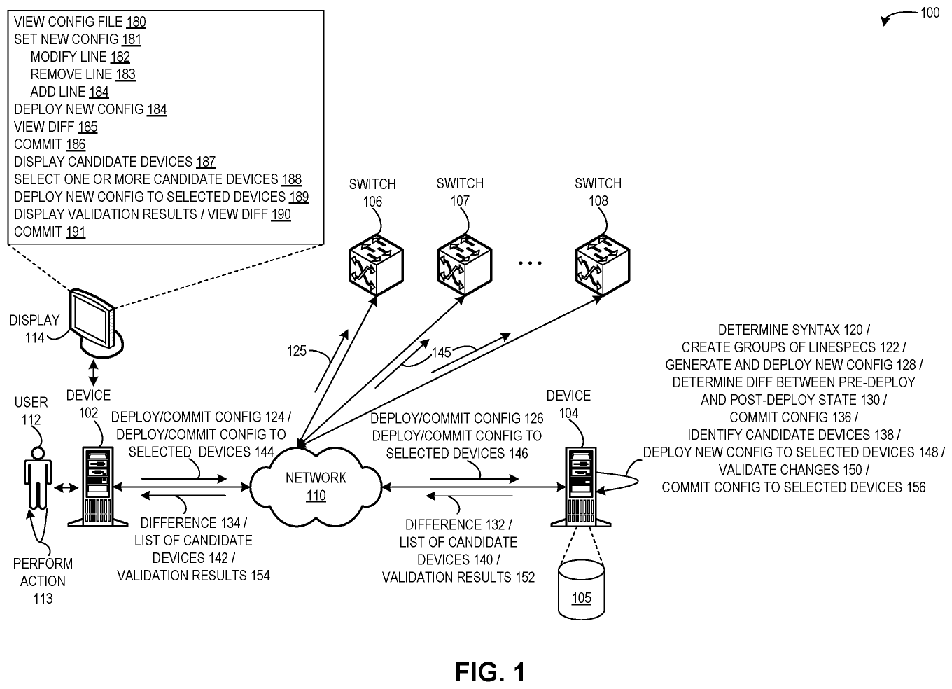

The system can allow a network administrator to make and deploy a configuration change and can also provide the network administrator with a view of the “changed data” (or the “difference” or “differential” data). The network administrator can then determine whether to confirm or commit the deployed configuration change. Based on the changed data, the linespec groups, and other criteria, the system can subsequently identify candidate devices to which to deploy a similar configuration change and provide the network administrator with a list of the candidate devices. The network administrator can select one or more of the candidate devices to which to deploy a configuration change. In response, the system can deploy a configuration change to the selected devices and provide similar changed or difference data views to the network administrator. The system can provide automatic validation of the changed or difference data and indicate the result of the validation to the network administrator, who can choose whether or not to commit a deployed configuration change. In some aspects, the system can automatically replicate a particular isolated change throughout the remainder of a managed network. A diagram with entities and communications for auto-detection and resolution of similar network misconfiguraton is described below in relation to FIG. 1.

In some aspects, the system can use machine learning over time to determine which candidate devices may be more likely to be selected for a given customer (or customers), and can also consolidate the changed or difference data across customers to identify common workflows.

Communications which Facilitate Auto-Detection and Resolution

FIG. 1 illustrates a diagram 100 with entities and communications which facilitate auto-detection and resolution of similar network misconfiguration, in accordance with an aspect of the present application. Diagram 100 can indicate an environment, which includes: a device 102, an associated user 112, and an associated display screen 114; a device 104 and an associated or included storage device 105; and devices 106, 107, and 108 (e.g., switches). Devices 102, 104, and 106-108 can communicate with each other via a network 110. Device 102 can be a client computing device, e.g., a laptop computer, a mobile telephone, a smartphone, a tablet, a desktop computer, and a handheld device. Devices 102, 104, and 106-108 can be a computing device, e.g., a server, a networked entity, and a communication device. Devices 106-108 can be any network device which is associated with a configuration file, such as a server or a switch. In some aspects, devices 102 and 104 (and their associated operations) can run on the same device or within switch 106.

During operation, device 104 can determine a syntax for each line of a plurality of lines in a configuration file for a switch (such as switch 106) operating in a network (operation 120). A respective line specification can indicate terms for a command in the configuration file. Device 104 can create, based on the syntax, one or more groups of line specifications (operation 122). Each line specification in a group can include matching terms or values specified by a user or both (operation 124).

Display 114 can include, indicate, or display various information to user 112, including actionable widgets and selectable lists or elements which can be activated or acted upon to send a command to device 104. That is, user 112 can perform an action 113 to activate any of the elements indicated in display 114. For example, user 112 may wish to create and deploy a new configuration for switch 106. User 112 can view the information displayed on display 114, and can perform action 113, e.g., to view a configuration (“config”) file for switch 106 (element 180) and to set a new configuration for switch 106 (element 181). User 112 can use a configuration grammar such as that used by a management application. In setting the new configuration, user 112 can modify a line, remove a line, or add a line (respectively, elements 182, 183, and 184). User 112 can use various configuration mechanisms, including: a command-line interface (CLI)-based textual editor which allows the user to set the new configuration using text; and a model-based editor which allows the user to set the new configuration using a JavaScript Object Notation (JSON) model. Thus, user 112 can enter new configurations which provide context, types, differences, etc. using a text-based or object-based editing tool or application.

User 112 can deploy the new configuration to switch 106 (element 184), which can result in sending a request to deploy the new configuration to device 104 (via a communication 124).

Device 104 can receive the request to deploy the new configuration (as a communication 126) and generate and deploy the new configuration for switch 106 (operation 128). Device 104 can determine a difference between a pre-deployment state and a post-deployment state of switch 106 (operation 130) and send the difference back to device 102 (as a difference 132). Device 102 can receive the difference (as a difference 134) and display the difference on display 114 (element 185). For example, element 185 may be displayed as two boxes next to each other, with the left-side box including an excerpt from the configuration file for switch 106 before the deployment (e.g., in a pre-deployment state) and the right-side box including the corresponding excerpt from the configuration file the switch 106 after the deployment (e.g., in a post-deployment state). The system can indicate the changed lines in each excerpt or box with different markings, including overlapping text, highlighting, overlay indicators, labels, and other visual indicators. User 112 can determine whether or not to commit the deployed changes to switch 106. For example, user 112 can send a commit configuration command to device 104 (using element 186 and via communication 124). Device 104 can receive the commit configuration command (as a commit configuration command 126) and commit the configuration command (operation 136).

Subsequently, the system can begin a propagation process, i.e., by identifying candidate devices to which to propagate the new configuration. Device 104 can identify candidate devices to which to deploy the new configuration (operation 138) and send a list of candidate devices 140 to device 102. Device 102 can receive the list of candidate devices 140 (as a list 142) and can display the list on display 114 (element 187). In some aspects, the system may display the candidate devices as a list with selectable elements, while in other aspects, the system may display the candidate devices as nodes in a connected graph with edges indicating relationships between the candidate devices. The displayed graph may also include indicators of common features between the devices, such as a same physical location or area (e.g., the same floor or building), a shared access switch, a shared pod switch, or other common or similar features. The displayed graph may also include selectable widgets which allow the user to select one or more candidate devices based on any combination of the common features. Based on various factors, the system may display the list of candidate devices in a particular ranked order or order of importance and may also indicate the order or ranking in the graph in a visual manner.

User 112 can select one or more of the candidate devices (e.g., in the list or graph format) (element 188) and deploy the new configuration to the selected devices (element 189), which can result in sending to device 104 a request to deploy the new configuration to the selected devices (via communication 124). Device 104 can receive the request to deploy the new configuration to the selected devices (as communication 126) and generate and deploy the new configuration to the selected devices (operation 148). Device 104 can validate the deployed new configuration to the selected devices (operation 150) and send validation results 152 back to device 102. Device 102 can receive the validation results (as validation results 154) and display the validation results on display 114 (element 190). The displayed validation results may allow the user to select to view the changed or difference data (i.e., the difference between the pre-deployment state and post-deployment state of a selected device to which the new configuration change was deployed), e.g., in a side-by-side manner as described above in relation to element 185 of FIG. 1.

Validation results 190 may also indicate whether the deployed new configuration was successful based on an automatic validation performed by device 104 and included in validation results 152/154. For example, validation results 152/154 can be based on a comparison algorithm which provides as output, for each detected difference in the changed or difference data: an indicator of whether a given value changed; and, if the value did change, an indicator of whether the changed value is the correct or expected value. Based on validation results 190, user 112 can determine to commit the new configuration to some, none, or all of the selected devices (element 191 and via communications 144 and 146 to device 104). Device 104 can receive the command to commit, and subsequently commit, the new configuration to the determined selected devices (operation 156).

A configuration change can be either deployed and committed or only committed via communications to a given switch, e.g., via a communication 125 to switch 106 for the initial new configuration and via a communication 145 to switches 107 and 108 for the propagation of the new configuration.

Linespecs and Linespec Groups

FIG. 2A illustrates a configuration grammar for an entry 200 in a configuration file and a hierarchical context 210, in accordance with an aspect of the present application. Entry 200 indicates a linespec, which can represent a line of a given configuration file using a certain syntax or grammar. Linespec 200 can specify the keywords, terms, and values which may appear for a given configuration command, e.g., that may be used by a network administrator when setting a configuration feature. For example, linespec 200 can be associated with a setting for the port speed, with various possible speed values. A linespec can be a rule of grammar which allows the system to identify one or more variations of textual content which are syntactically valid, while a line can be a particular string of textual content that may or may not be syntactically valid. When a line matches a linespec, the line is shown to be syntactically valid. The line (i.e., a specific instance) which matches a linespec 200 (also indicated as an entry/linespec 212 in a context 210) (i.e., a syntactic specification) can be seen in a line 222 of FIG. 2B.

Each linespec may be defined within a particular hierarchical context. Context 210 can include the port speed linespec command (200), along with other linespecs relating to, e.g., a description of the context, shutdown features relating to the context, and features related to a virtual local area network (VLAN). The commands in context 210, taken together, can determine the set of valid commands which may appear within a particular context (e.g., the interface context depicted in 210), as provided by a network administrator.

FIG. 2B illustrates a set 220 of instructions for a switch configuration, in accordance with an aspect of the present application. Set 220 can define, in an interface context (corresponding to context 210 of FIG. 2A), a configuration for a switch, including keywords, terms, and values. For example: an entry for the term “description” can have a value of “Upstairs hall printer”; a value of “no shutdown” can be indicated; the term “speed auto” can be set to a value of “100 m”; the term “vlan trunk native” can be set to a value of “3”; and the term “vlan trunk allowed” can be set to a value of “1-10, 20-30.” The system does not require a line for every linespec (e.g., the number of lines in configuration set 220 does not match the number of commands in context 210). In some aspects, multiple lines/instructions may correspond to a single linespec. For example, the configuration may include:

vlan trunk allowed 2-10

vlan trunk allowed 20-25

vlan trunk allowed 23-30

vlan trunk allowed 1

These multiple lines would all refer to the same linespec 214 in 210. Taken in the aggregate, the multiple lines would represent the setting:

vlan trunk allowed 1-10,20-30

Another example of multiple lines corresponding to the same linespec can be seen in static routes:

ip route 1.1.1.0/24 5.5.5.5

ip route 2.2.2.0/30 5.5.5.5

ip route 3.3.3.3/32 6.6.6.6

Note that for the lines which do appear in configuration set 220, the syntax must match the linespec and appear in the same order as the linespec ordering in context 210 for “INTERFACE_NODE.”

Within a given context, multiple linespecs may refer to the same logical configuration, but may be based on a different ordering for terms or keywords. FIG. 2C illustrates two linespecs 230 which refer to the same logical configuration, in accordance with an aspect of the present application. A linespec 232 includes the term “(dot1x)” prior to the term “(mac-auth),” while a linespec 234 includes the terms in the reverse order, i.e., the term “(mac-auth)” appears prior to the term “(dot1x).” The commands indicated by linespecs 232 and 234 can relate logically to the same configuration, however, these linespecs specify a different precedence for the “dot1x” and “mac-auth” terms. The aspects of the present application can create a logical grouping of these linespecs into various groups or “linespec groups.” A linespec group can be defined as a set of linespecs where each and every member of the group either has the same terms/values that the user can specify or defines defaults for any terms/values which are not explicated specified or stated. For example, in a static route the virtual routing and forwarding (VRF) is assumed to be “default” if not defined, such that the following can be considered as equal:

ip route 1.1.1.0/24 5.5.5.5

ip route 1.1.1.0/24 5.5.5.5 vrf default

FIG. 3 illustrates a linespec group 300 for port-access security violations and a corresponding definition, in accordance with an aspect of the present application. Linespec group 300 can include four commands 302, 304, 306, and 308, all of which are related to or associated with port-access security violations. In the described aspects, either a user can manually create the linespec groups or the system can automatically create the linespec groups, e.g., based on machine learning or a clustering algorithm. A resulting linespec group 310 for commands related to or associated with the port-access security violations can include: a group “name” of “pvsa” with various “terms” in the group; a first term with a “name” of “notify” and a “default” value of “false”; a second term with a “name” of “shutdown” and a “default” value of “false”; a third term with a “name” of “auto-recovery” and a “default” value of “false”; and a fourth term with a name of “recovery-timer” and a default value of “10.”

Linespecs 302-308 all begin with the same prefix “port-access security violation action” and thus can be grouped into the group named “pvsa” with the terms being assigned various default values. Linespec group 310 can define the terms which apply to the group can also define the default values for the terms, which can override those of the group.

As described above, the system can create the linespec groups based on machine learning or a clustering algorithm. The system can perform the clustering by making a pass over the grammar to identify each and every term which occurs in any linespec, which can result in a set of unique terms for the entire grammar (where the set can have a size of T). Each of the terms in the set T can be used as a dimension in a two-dimensional matrix where the dimensions are T (total number of terms) and L (total number of linespecs). For each linespec, the system can increment the corresponding term dimension for every instance of that term within the linespec.

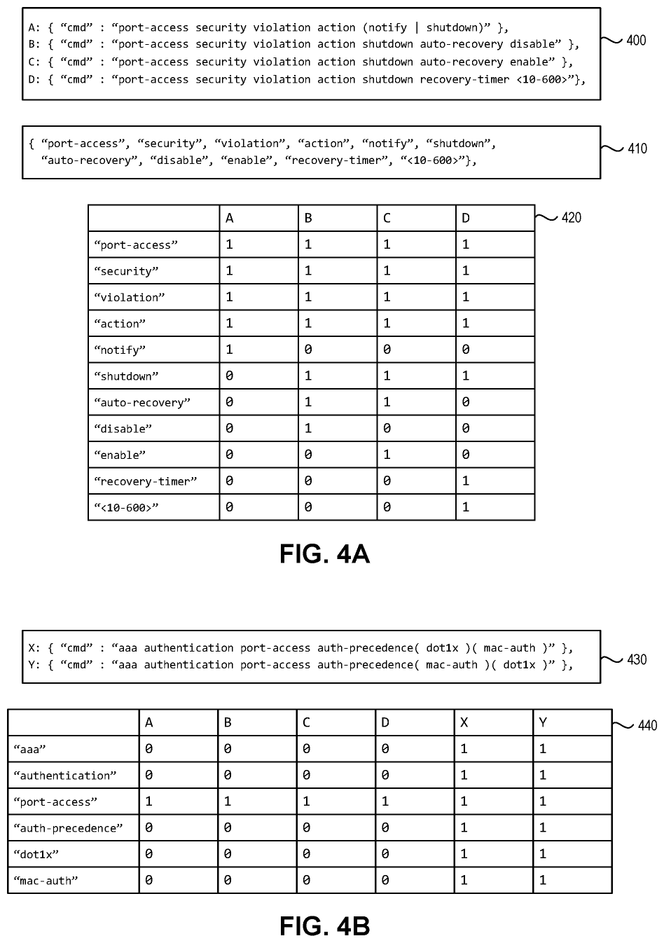

FIG. 4A illustrates linespecs 400, corresponding terms 410, and a corresponding matrix 420, in accordance with an aspect of the present application. Given the four linespecs A-D in linespecs 400, the total number of terms can be T=11, as shown in corresponding terms 410. That is, a set 410 of size T=11 can include one instance of each unique term from all of linespecs A-D of linespecs 400. Set 410 can include the following terms: “port-access”, “security”, “violation”, “action”, “notify”, “shutdown”, “auto-recovery”, “disable”, “enable”, “recovery-timer”, and “<10-600>.”

Matrix 420 can include columns corresponding to linespecs A-D of linespecs 400 and rows corresponding to each of the 11 (or T) terms. Each entry in matrix 420 can have a value of either “0” which indicates that the term does not appear in the given linespec or “1” which indicates that the term does appear in the given linespec. Using matrix 420, the system can ignore ordering, as linespecs would equate to the same point in T-dimensional space, as shown in FIG. 4B.

FIG. 4B illustrates linespecs 430 and a matrix 440 which illustrates the distinction between the linespecs in FIG. 4B and the linespecs in FIG. 4A, in accordance with an aspect of the present application. Linespecs 430 can include linespecs X and Y (which are similar to linespecs 230 of FIG. 2C). Matrix 440 can indicate an example of linespecs A-D and linespecs X-Y, indicated as columns and placed in a same matrix. The rows of matrix 440 can correspond to the terms which appear in one or both of linespecs A-D and X-Y. Matrix 440 is provided to illustrate the results of applying a clustering algorithm to the set of terms where the number of terms Tis equal to “6.” The system can apply the clustering algorithm on a larger dimensional matrix, e.g., based on a maximum number of unique terms possible in the linespecs which are used to define the configuration files for network devices.

Thus, in FIG. 4B, the rows of matrix 440 can correspond to the six unique terms which appear in the linespecs X and Y: “aaa”, “authentication”, “port-access”, “auth-precedence”, “dot1x”, and “mac-auth.” Matrix 440 clearly depicts the distinction between the linespecs A-D and X-Y. The system can apply a traditional clustering algorithm (e.g., K-means, density-based spatial clustering of applications with noise (DBSCAN), and hierarchical clustering) to any T-dimensional matrix to identify clusters of related linespecs, and cluster notations may be used to annotate a linespec with a certain “group” label. In FIG. 4B, the applied clustering algorithm can determine that the linespecs X and Y can be grouped together in a linespec group and that linespecs X-Y are different from linespecs A-D. Given only matrix 440, the system may group linespecs A-D together, as the identical matching and non-matching terms may be sufficient in quantity or likeness to be grouped together by the clustering algorithm.

As described above, a network administrator may create and deploy a new configuration to a first device, and may wish to deploy the new configuration to a plurality of other devices. When the system saves or deploys a new configuration to a given switch or network device, the system can determine a difference between the pre-deployment state (e.g., existing configurations) and the post-deployment state (e.g., new configurations) of the given switch or network device. For each line that is changed, the system can record or store information associated with the changed lines, such as: the line number for a changed line; a type of line change for the changed line, including whether the line was added, removed, or modified; a group associated with the changed line; if the changed line was modified, for each changed term, a previous value and a current value; whether the changed line existed in a same context but was not modified; and for the changed line, which device was changed, including information associated with the changed device (e.g., device identifier, model, version number, etc.).

Once the system has deployed the new configuration or change to the network, the system can use integrated tools to verify that the change results in the intended effect on the network. For example, the system can validate the deployed new configuration (i.e., validate the change or display validation results) by comparing “show command” output from before and after the change to characterize the effect. The network administrator may visually inspect the effect of the change and analyze the changed or difference data. This can allow the network administrator to review the changes and decide whether to commit the deployed changes based on the validation results.

Identifying Candidate Devices on which to Deploy a Configuration Change; Machine Learning; and Automatic Validation

The described aspects can use the changed or difference data to identify other configurations or candidate devices to which to apply the same configuration change. The system can look for a configuration state which matches the pre-deployment state where the change was applied. In general, if the pre-deployment state matches, then that matching configuration is a likely candidate to which to apply the configuration change. The term “state” can refer to the output of a “show command” request, the physical topology of a network, and neighbors of a particular device or switch. The term “state” can also include immutable characteristics of a switch itself (e.g., model, port count, feature support) or an assigned switch role (e.g., aggregation, access, core, border, etc.).

The system can use a named resource (such as an access control list (ACL) or a policy) to determine the candidate devices to which to apply the configuration change. For example, if the network administrator deploys a configuration change to an ACL named “Printer Traffic,” it is likely that the network administrator may wish to modify other switches which have an ACL with the same name. Instead of requiring the network administrator to use a text-based search for the term “Printer Traffic,” which may result in matching other configuration blocks using the term in text, the described aspects can automatically identify all other instances of that ACL named “Printer Traffic” as candidate devices. Because named resources may differ in terms of content and definition, the described aspect can optionally compare the named resource content to determine the most likely candidate devices.

The system can thus match for a specific main criteria and search for any configuration which, for every changed line, contains at least one line which matches the same linespec group (e.g., a group associated with the changed line). The system can optimize the search by indexing the device configurations by linespec. If a particular configuration does not match the main criteria, the system can exclude that particular configuration from the remainder of the analysis. Not every matching configuration may necessarily be a good candidate to which to apply the configuration change. The system can order the list of possible candidates based on several factors, including: whether a respective configuration for one of the other devices contains all or “many” unmodified lines in a same context (where the system can perform the search using a plaintext search and where “many” may be based on a predetermined threshold or number); whether the respective configuration is associated with a same type of device as a device type associated with the new configuration (e.g., the same identifier, model, or version number); whether a respective changed line (if modified or removed) in the respective configuration includes a first value for a term which is closer to a second value for a term of the pre-deployment state (where “closer” may be based on a predetermined or user-defined threshold based on the highest value for the term in a most recent post-deployment state); and whether the respective changed line (if modified or removed) matches a same linespec as a line in the respective configuration.

The system can display this “likelihood-ordered list” or “change ranking” to the network administrator, in either a list format or a graphical format as described above in relation to element 187 of FIG. 1. For example, the network administrator may use a graphical topology-viewing tool to determine how the devices, switches, and/or configuration files are inter-related. The network administrator may visually inspect the list or graphical format to determine the scope of the proposed changes (e.g., to the candidate devices) and subsequently determine whether to accept or reject the proposed changes (e.g., select one or more of the candidate devices to which to deploy the new configuration). In some aspects, the system can automatically apply the changes to all identified candidate devices which meet a certain predetermined threshold (e.g., based on any of the above-described criteria or likelihood factors, or the predetermined or user-defined threshold for “closeness” in certain linespec changes). The system can thus display the candidate devices, deploy the new configuration to the user-selected (or automatically determined entirety of) candidate devices, and provide the changed or difference data via the integrated change validation tools, thereby allowing the network administrator to select which devices/configurations to accept (i.e., commit) or reject.

The system can also use machine learning, based on the change ranking (e.g., the likelihood-ordered list of candidate devices), to train a model over time with feedback from the network administrator. The system can track which candidates are chosen by the network administrator to be included/excluded from the likelihood-ordered list. If an administrator excludes a candidate, the system may lower a weight for the corresponding characteristics of the changes which match the original change. If an administrator includes a candidate, the system may increase this weight.

The system can also consolidate the changed lines and stored information across all customers to “smooth” the data down to certain essential linespecs and context. This consolidation may allow the system to group customers by similar behavior and identify common workflows, which can be used to provide feedback and increase efficiency in certain sales and support groups. For example, sales and support groups may use the consolidated information to create training material directed at the most common customer workflows.

The system can also track which features are being changed. A frequently changed configuration may indicate that a customer is encountering difficulties in configuring the feature. The system can distinguish between “enabling a new feature” and “fixing a bad configuration for the feature” based on whether a corresponding line is removed/modified or whether the line is added. By consolidating this information across all customers, the system can provide a global view of which features (or specific commands) may be more problematic for configuration by customers. Furthermore, this information may be useful to teams which provide documentation, training, implementation, or testing for those features for which more may help may be needed if the feature is not otherwise known to be difficult to configure.

As described above, because the system can record the changed or difference data using the integrated tools, the system can perform validation by comparing the pre-deployment state and the post-deployment state (as described above in relation to 150 and 190 in FIG. 1). That is, the system can obtain one or more changed lines by performing this difference function or comparison. The resulting changed or difference data may not exactly match due to aspects or local values of network state which may change based on location (e.g., host names, IP addresses, or port numbers). The system can place these local values in either the candidate device's configuration text or extract values from a neighbor table (e.g., a Link Layer Discovery Protocol (LLDP) or other protocol state table) to identify which values in the configuration text would need to be abstracted/replaced. This can result in effectively masking out these local values or differences. A neighbor table can identify characteristics (e.g., Internet Protocol (IP) address, media access control (MAC) address, hostname, or port number) of an entity which is connected to the system or switch. Neighbor characteristics may appear in a switch configuration. For example, the switch may have an L3 neighbor (e.g., a router) with the IP address 5.5.5.5. This IP address may appear in the switch's configuration in static routes as a nexthop:

ip route 1.1.1.0/24 5.5.5.5

ip route 2.2.0.0/16 5.5.5.5

In validating the deployed new configuration (e.g., in performing the change validation), the system can determine, for each detected difference in the changed or difference data: whether the value changed; and if the value changed, whether the value changed to the correct value. If the value changed and is different between the original change and the auto-applied change, the detected difference will automatically fail the validation. If the value did change, the system can determine whether the value changed to the correct value. The system can characterize the changed value in the original difference data. The system can extract the changed value and search for the changed value in the configuration text and in neighbor/protocol state tables and can record relevant contexts associated with these search results. The system can analyze the difference data for each auto-applied change by checking whether the same context/characteristics are found for the changed value. If so, the system can automatically validate the change. If not, the system can present the change to the network administrator as a potentially invalid result.

Method which Facilitates Auto-Detection and Resolution

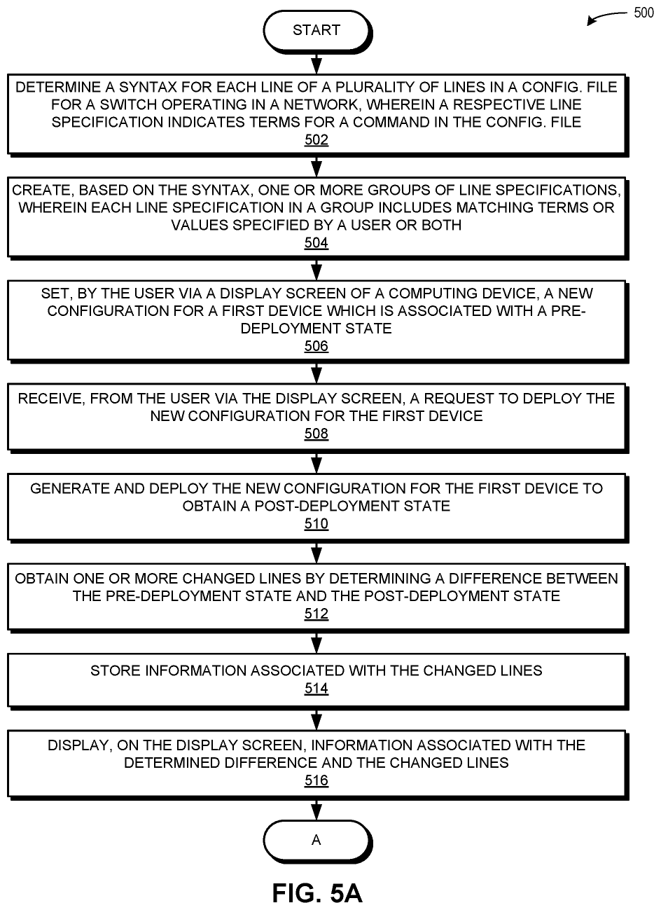

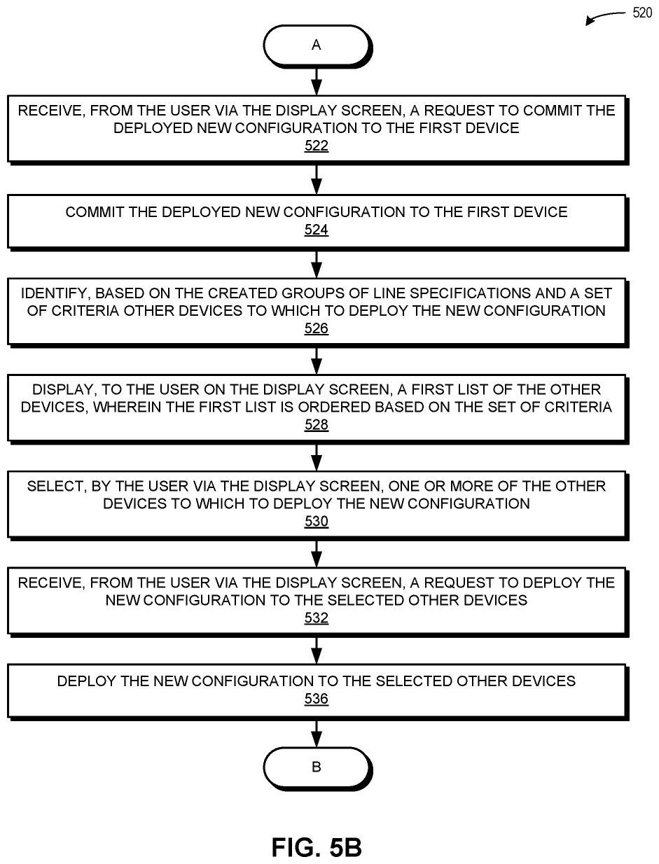

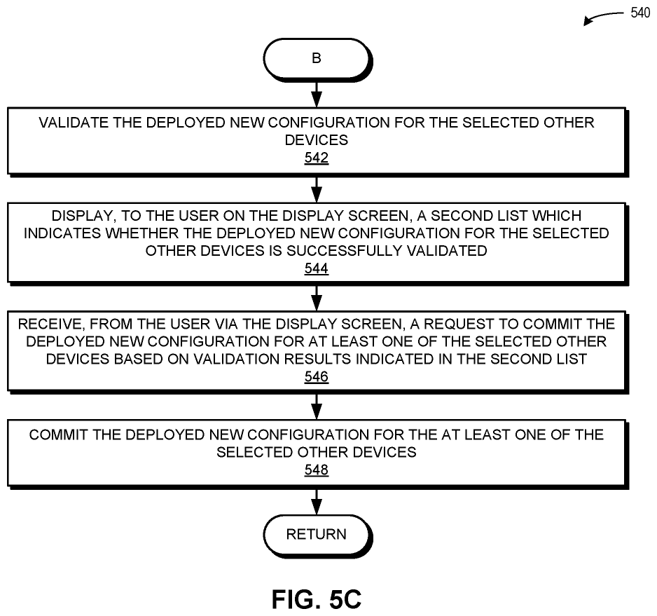

FIG. 5A presents a flowchart 500 illustrating a method which facilitates auto-detection and resolution of similar network misconfiguration, in accordance with an aspect of the present application. During operation, the system determines a syntax for each line of a plurality of lines in a configuration file for a switch operating in a network, wherein a respective line specification indicates terms for a command in the configuration file (operation 502). The system creates, based on the syntax, one or more groups of line specifications, wherein each line specification in a group includes matching terms or values specified by a user or both (operation 504). The system sets, by the user via a display screen of a computing device, a new configuration for a first device which is associated with a pre-deployment state (operation 506). The system receives, from the user via the display screen, a request to deploy the new configuration for the first device (operation 508). The system generates and deploys the new configuration for the first device to obtain a post-deployment state (operation 510). The system obtains one or more changed lines by determining a difference between the pre-deployment state and the post-deployment state (operation 512). The system stores information associated with the changed lines (operation 514). The system displays, on the display screen, information associated with the determined difference and the changed lines (operation 516), and the operation continues at Label A of FIG. 5B.

FIG. 5B presents a flowchart 520 illustrating a method which facilitates auto-detection and resolution of similar network misconfiguration, in accordance with an aspect of the present application. The system receives, from the user via the display screen, a request to commit the deployed new configuration to the first device (operation 522). The system commits the deployed new configuration to the first device (operation 524). The system identifies, based on the created groups of line specifications and a set of criteria, other devices to which to deploy the new configuration (operation 526). The system can identify the other devices further based on the new configuration. The system displays, to the user on the display screen, a first list of the other devices, wherein the first list is ordered based on the set of criteria (operation 528). The system selects, by the user via the display screen, one or more of the other devices to which to deploy the new configuration (operation 530). The system receives, from the user via the display screen, a request to deploy the new configuration to the selected other devices (operation 532). The system deploys the new configuration to the selected other devices (operation 534), and the operation continues at Label B of FIG. 5C.

FIG. 5C presents a flowchart 540 illustrating a method which facilitates auto-detection and resolution of similar network misconfiguration, in accordance with an aspect of the present application. The system validates the deployed new configuration for the selected other devices (operation 542). The system displays, to the user on the display screen, a second list which indicates whether the deployed new configuration for the selected other devices is successfully validated (operation 544). The system receives, from the user via the display screen, a request to commit the deployed new configuration for at least one of the selected other devices based on validation results indicated in the second list (operation 546). The system commits the deployed new configuration for the at least one of the selected other devices (operation 548), and the operation returns.

While flowcharts 500, 520, and 540 depict operations occurring sequentially, some operations may occur in parallel. For example, upon performing operation 508, another device (such as device 104 in FIG. 1) may begin executing operation 526 in parallel (assuming that the configuration will be deployed and the user will commit the change). In executing operation 526, the system may use information which was previously calculated, rather than calculating the information on-demand. For example, the system may track changes to neighbor tables as they occur. When an entry changes in a neighbor table for a given neighbor, the system can parse the configuration for switches adjacent to the given neighbor and correlate which terms in the configuration relate to the given neighbor. Subsequently, upon executing operation 526, the system will already have the abstraction data cached to identify similar lines.

Computer System and Apparatus

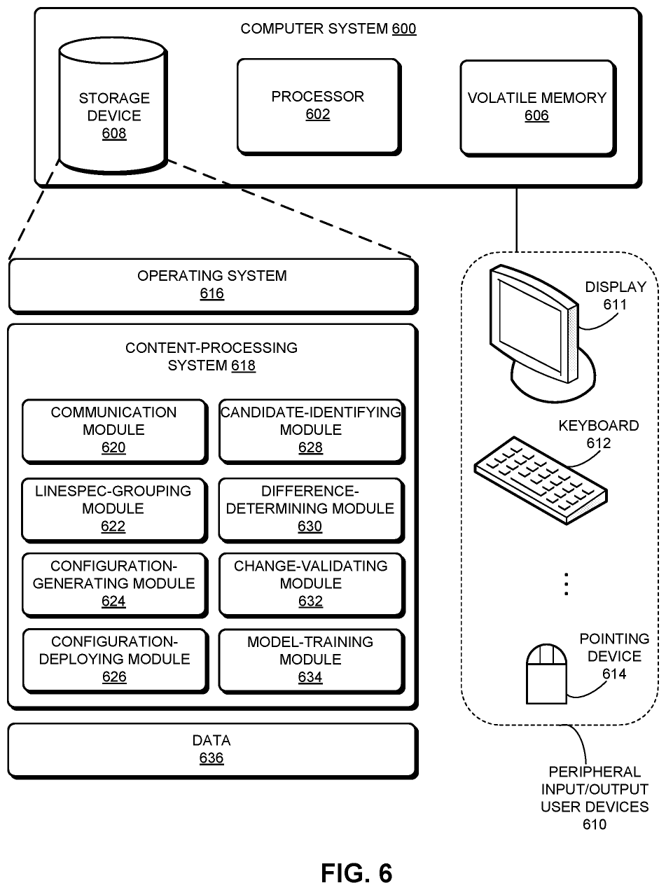

FIG. 6 illustrates a computer system which facilitates auto-detection and resolution of similar network misconfiguration, in accordance with an aspect of the present application. Computer system 600 includes a processor 602, a volatile memory 606, and a storage device 608. Volatile memory 606 can include, e.g., random access memory (RAM), that serves as a managed memory, and can be used to store one or more memory pools. Storage device 608 can include persistent storage which can be managed or accessed via processor 602. Furthermore, computer system 600 can be coupled to peripheral input/output (I/O) user devices 610, e.g., a display device 611, a keyboard 612, and a pointing device 614. Storage device 608 can store an operating system 616, a content-processing system 618, and data 636. Computer system 600 may include fewer or more modules than those shown in FIG. 6.

Content-processing system 618 can include instructions, which when executed by computer system 600, can cause computer system 600 or processor 602 to perform methods and/or processes described in this disclosure. Specifically, content-processing system 618 can include instructions for receiving and transmitting data packets, instructions relating to configuration files, requests, and commands (communication module 620).

Content-processing system 618 can further include instructions for determining a syntax for each line of a plurality of lines in a configuration file for a switch operating in a network, wherein a respective line indicates terms for a command in the configuration file (linespec-grouping module 622). Content-processing system 618 can include instructions for creating, based on the syntax, one or more groups of lines, wherein each line in a group includes matching terms or values specified by a user or both (linespec-grouping module 622). Content-processing system 618 can include instructions for generating a new configuration for a first device which is associated with a pre-deployment state (configuration-generating module 624) and deploying the new configuration to the first device to obtain a post-deployment state (configuration-deploying module 626). Content-processing system 618 can include instructions for obtaining one or more changed lines by determining a difference between the pre-deployment state and the post-deployment state (difference-determining module 630). Content-processing system 618 can include instructions for storing information associated with the changed lines (difference-determining module 630). Content-processing system 618 can include instructions for identifying, based on the created groups of lines and a set of criteria, other devices to which to deploy the new configuration (candidate-identifying module 628). Content-processing system 618 can include instructions for displaying, to a user on a display screen of a computing device, a first list of the other devices, wherein the first list is ordered based on the set of criteria (candidate-identifying module 628). Content-processing system 618 can include instructions for selecting, by the user, one or more of the other devices to which to deploy the new configuration (candidate-identifying module 628). Content-processing system 618 can include instructions for deploying the new configuration to the selected other devices (configuration-deploying module 626). Content-processing system 618 can include instructions for validating the deployed new configuration to the selected other devices (change-validating module 632). Content-processing system 618 can include instructions for displaying, to the user on the display screen, a second list which indicates whether the deployed new configuration to the selected other devices is successfully validated (change-validating module 632).

Content-processing system 618 can additionally include instructions for: training a model, based on the generated new configuration and the selected other devices, to learn which configurations are more likely for a customer of a plurality of customers; consolidating the changed lines and stored information across the plurality of customers to identify common workflows; and training the model further based on tracking actions associated with the customer to learn which configurations are more likely for the customer (model-training module 634).

Data 636 can include any data that is required as input or generated as output by the methods and/or processes described in this disclosure. Specifically, data 636 can store at least: a syntax; a line; a modified or unmodified line; a linespec; a group of lines; a linespec group; a term; a value; a default value; a keyword; a configuration; a configuration file; a changed line; a difference; changed data; difference data; differential data; a result of a comparison; an indicator of a device or a candidate device; a list of devices; a selected device; a validated device; an indicator of a successful validation of a deployed configuration; a model; an indicator or identifier for a customer; a workflow; an action; a number; a clustering algorithm; a matrix; a visual similarity; a named resource; criteria; a matching line, linespec, or linespec group for a respective changed line; information associated with a device; a pre-deployment state; a post-deployment state; a line number; a line change type; a previous value; a current value; and a context.

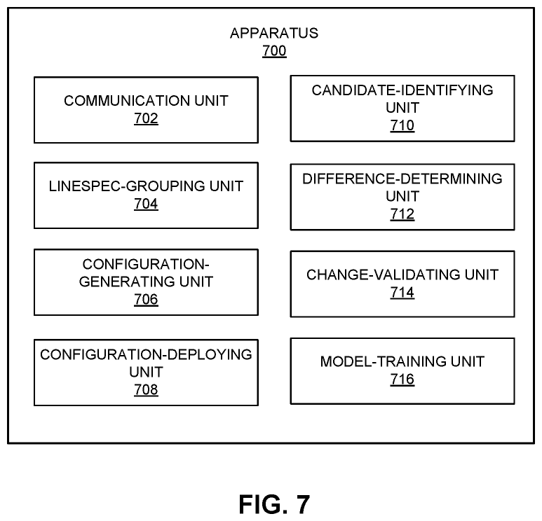

FIG. 7 illustrates an apparatus 700 which facilitates auto-detection and resolution of similar network misconfiguration, in accordance with an aspect of the present application. Apparatus 700 can comprise a plurality of units or apparatuses which may communicate with one another via a wired, wireless, quantum light, or electrical communication channel. Apparatus 700 may be realized using one or more integrated circuits, and may include fewer or more units or apparatuses than those shown in FIG. 7. Furthermore, apparatus 700 may be integrated in a computer system, or realized as a separate device or devices capable of communicating with other computer systems and/or devices.

Apparatus 700 may also include a non-volatile storage system or a memory management unit. Apparatus 700 can comprise modules or units 702-716 which are configured to perform functions or operations similar to modules 620-634 of computer system 600 of FIG. 6, including: a communication unit 702; a linespec-grouping unit 704; a configuration-generating unit 706; a configuration-deploying unit 708; a candidate-identifying unit 710; a difference-determining unit 712; a change-validating unit 714; and a model-training unit 716.

In general, the disclosed aspects provide a system which facilitates processing an instruction. In one aspect, during operation, the system determines a syntax for each line of a plurality of lines in a configuration file for a switch operating in a network, wherein a respective line specification indicates terms for a command in the configuration file. The system creates, based on the syntax, one or more groups of line specifications, wherein each line specification in a group includes matching terms or values specified by a user or both. The system generates, a new configuration for a first device which is associated with a pre-deployment state. The system deploys the new configuration to the first device to obtain a post-deployment state. The system obtains one or more changed lines by determining a difference between the pre-deployment state and the post-deployment state. The system stores information associated with the changed lines. The system identifies, based on the created groups of line specifications and a set of criteria, other devices to which to deploy the new configuration, and displays, to a user on a display screen of a computing device, a first list of the other devices, wherein the first list is ordered based on the set of criteria. The system selects, by the user, one or more of the other devices to which to deploy the new configuration, and deploys the new configuration to the selected other devices. The system validates the deployed new configuration for the selected other devices, and displays, to the user on the display screen, a second list which indicates whether the deployed new configuration for the selected other devices is successfully validated.

In a variation on this aspect, the system trains a model, based on the generated new configuration and the selected other devices, to learn which configurations are more likely for a customer of a plurality of customers. The system consolidates the changed lines and stored information across the plurality of customers to identify common workflows.

In another variation on this aspect, the system trains the model further based on tracking actions associated with the customer to learn which configurations are more likely for the customer, wherein a tracked action includes at least one of: a number of times that a respective configuration file of a plurality of configurations files is viewed; a number of times that a line of a plurality of lines in the respective configuration file is viewed, clicked on, modified, changed, or removed; whether a respective device of the displayed first list of the other devices is selected by the user; and whether the new configuration is deployed to the respective device.

In a further variation, the respective line specification further indicates keywords and values for the command in the configuration file.

In a further variation, each line specification in a group further includes default values for terms and/or values which are not specified.

In a further variation, the system creates the one or more groups of lines based on at least one of: a clustering algorithm; and a visual similarity identified by a user.

In a further variation, the system identifies the other devices to which to deploy the new configuration is based on a named resource.

In a further variation, the set of criteria comprises whether a current state of a respective other device matches the pre-deployment state of the first device.

In a further variation, identifying the other devices to which to deploy the new configuration is further based on searching, in a plurality of configurations for the other devices, for any configuration which, for every changed line, contains at least one line which matches a group associated with the respective changed line.

In a further variation, ordering the first list of the other devices based on the set of criteria comprises ranking the other devices based on at least one of: whether a respective configuration for one of the other devices contains all or many unmodified lines in a same context; whether the respective configuration is associated with a same type of device as a device type associated with the new configuration; whether a respective changed line in the respective configuration includes a first value for a term which is closer to a second value for a term of the pre-deployment state; and whether the respective changed line matches a same line specification as a line in the respective configuration.

In a further variation, the stored information associated with the changed lines comprises, for each changed line, at least one of: a line number for a respective changed line; a type of line change for the respective changed line, including whether the line was added, removed, or modified; a group associated with the respective changed line; if the respective changed line was modified, for each changed term, a previous value and a current value; whether the respective changed line existed in a same context but was not modified; and for the respective changed line, which device was changed, including information associated with a respective changed device

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware devices or apparatus. For example, the hardware devices or apparatus can include, but are not limited to, application-specific integrated circuit (ASIC) chips, field-programmable gate arrays (FPGAs), dedicated or shared processors that execute a particular software program or a piece of code at a particular time, and other programmable-logic devices now known or later developed. When the hardware devices or apparatus are activated, the hardware modules perform the methods and processes included within them.

The foregoing descriptions of aspects have been presented for purposes of illustration and description only. They are not intended to be exhaustive or to limit the aspects described herein to the forms disclosed. Accordingly, many modifications and variations will be apparent to practitioners skilled in the art. Additionally, the above disclosure is not intended to limit the aspects described herein. The scope of the aspects described herein is defined by the appended claims.

1. A computer-implemented method, comprising:
determining a syntax for each line of a plurality of lines in a configuration file for a switch operating in a network, wherein a respective line specification indicates terms for a command in the configuration file;
creating, based on the syntax, one or more groups of line specifications, wherein each line specification in a group includes matching terms or values specified by a user or both;
generating a new configuration for a first device which is associated with a pre-deployment state;
deploying the new configuration to the first device to obtain a post-deployment state;
obtaining one or more changed lines by determining a difference between the pre-deployment state and the post-deployment state;
storing information associated with the changed lines;
identifying, based on the created groups of line specifications and a set of criteria, other devices to which to deploy the new configuration;
ordering a first list of the other devices by ranking the other devices based on the criteria, which includes at least whether a respective changed line in a respective configuration for one of the other devices includes a first value for a term which is closer, based on a predetermined threshold, to a second value for a term of the pre-deployment state;
displaying, to a user on a display screen of a computing device, the ordered first list of the other devices;
selecting, by the user, one or more of the other devices to which to deploy the new configuration;
deploying the new configuration to the selected other devices;
validating the deployed new configuration for the selected other devices; and
displaying, to the user on the display screen, a second list which indicates whether the deployed new configuration for the selected other devices is successfully validated.

2. The method of claim 1, further comprising:
training a model, based on the generated new configuration and the selected other devices, to learn which configurations are more likely for a customer of a plurality of customers; and
consolidating the changed lines and stored information across the plurality of customers to identify common workflows.

3. The method of claim 2, further comprising:
training the model further based on tracking actions associated with the customer to learn which configurations are more likely for the customer, wherein a tracked action includes at least one of:
a number of times that a respective configuration file of a plurality of configurations files is viewed;
a number of times that a line of a plurality of lines in the respective configuration file is viewed, clicked on, modified, changed, or removed;
whether a respective device of the displayed first list of the other devices is selected by the user; and
whether the new configuration is deployed to the respective device.

4. The method of claim 1,
wherein the respective line specification further indicates keywords and values for the command in the configuration file.

5. The method of claim 1,
wherein each line specification in a group further includes default values for terms and/or values which are not specified.

6. The method of claim 1, further comprising:
creating the one or more groups of lines based on at least one of:
a clustering algorithm; and
a visual similarity identified by a user.

7. The method of claim 1,
wherein identifying the other devices to which to deploy the new configuration is based on a named resource.

8. The method of claim 1,
wherein the set of criteria comprises whether a current state of a respective other device matches the pre-deployment state of the first device.

9. The method of claim 1,
wherein identifying the other devices to which to deploy the new configuration is further based on searching, in a plurality of configurations for the other devices, for any configuration which, for every changed line, contains at least one line which matches a group associated with the respective changed line.

10. The method of claim 1, wherein ranking the other devices is based on the criteria, which further includes at least one of:
whether a respective configuration for one of the other devices contains all or many unmodified lines in a same context;
whether the respective configuration is associated with a same type of device as a device type associated with the new configuration;
and
whether the respective changed line matches a same line specification as a line in the respective configuration.

11. The method of claim 1, wherein the stored information associated with the changed lines comprises, for each changed line, at least one of:
a line number for a respective changed line;
a type of line change for the respective changed line, including whether the line was added, removed, or modified;
a group associated with the respective changed line;
if the respective changed line was modified, for each changed term, a previous value and a current value;
whether the respective changed line existed in a same context but was not modified; and
for the respective changed line, which device was changed, including information associated with a respective changed device.

12. A computer system, comprising:
a processor; and
a memory coupled to the processor and storing instructions which, when executed by the processor, cause the processor to perform a method, the method comprising:
determining a syntax for each line of a plurality of lines in a configuration file for a switch operating in a network, wherein a respective line specification indicates terms for a command in the configuration file;
creating, based on the syntax, one or more groups of line specifications, wherein each line specification in a group includes matching terms or values specified by a user or both;
generating a new configuration for a first device which is associated with a pre-deployment state;
deploying the new configuration to the first device to obtain a post-deployment state;
obtaining one or more changed lines by determining a difference between the pre-deployment state and the post-deployment state;
storing information associated with the changed lines;
identifying, based on the created groups of line specifications and a set of criteria, other devices to which to deploy the new configuration;
ordering a first list of the other devices by ranking the other devices based on the criteria, which includes at least whether a respective changed line in a respective configuration for one of the other devices includes a first value for a term which is closer, based on a predetermined threshold, to a second value for a term of the pre-deployment state;
displaying, to a user on a display screen of a computing device, the ordered first list of the other devices;
selecting, by the user, one or more of the other devices to which to deploy the new configuration;
deploying the new configuration to the selected other devices;
validating the deployed new configuration for the selected other devices; and
displaying, to the user on the display screen, a second list which indicates whether the deployed new configuration for the selected other devices is successfully validated.

13. The computer system of claim 12, wherein the method further comprises:
training a model, based on the generated new configuration and the selected other devices, to learn which configurations are more likely for a customer of a plurality of customers; and
consolidating the changed lines and stored information across the plurality of customers to identify common workflows.

14. The computer system of claim 13, wherein the method further comprises:
training the model further based on tracking actions associated with the customer to learn which configurations are more likely for the customer, wherein a tracked action includes at least one of:
a number of times that a respective configuration file of a plurality of configurations files is viewed;
a number of times that a line of a plurality of lines in the respective configuration file is viewed, clicked on, modified, changed, or removed;
whether a respective device of the displayed first list of the other devices is selected by the user; and
whether the new configuration is deployed to the respective device.

15. The computer system of claim 12, wherein the method further comprises:
creating the one or more groups of lines based on at least one of:
a clustering algorithm; and
a visual similarity identified by a user.

16. The computer system of claim 12,
wherein the set of criteria comprises whether a current state of a respective other device matches the pre-deployment state of the first device.

17. The computer system of claim 12,
wherein identifying the other devices to which to deploy the new configuration is further based on searching, in a plurality of configurations for the other devices, for any configuration which, for every changed line, contains at least one line which matches a group associated with the respective changed line.

18. The computer system of claim 12, wherein ranking the other devices is based on the criteria, which further includes at least one of:
whether a respective configuration for one of the other devices contains all or many unmodified lines in a same context;
whether the respective configuration is associated with a same type of device as a device type associated with the new configuration;
and
whether the respective changed line matches a same line specification as a line in the respective configuration.

19. The computer system of claim 12, wherein the stored information associated with the changed lines comprises, for each changed line, at least one of:
a line number for a respective changed line;
a type of line change for the respective changed line, including whether the line was added, removed, or modified;
a group associated with the respective changed line;
if the respective changed line was modified, for each changed term, a previous value and a current value;
whether the respective changed line existed in a same context but was not modified; and
for the respective changed line, which device was changed, including information associated with a respective changed device.

20. A non-transitory computer-readable storage medium storing instructions that when executed by a computer cause the computer to perform a method, the method comprising:
determining a syntax for each line of a plurality of lines in a configuration file for a switch operating in a network, wherein a respective line specification indicates terms for a command in the configuration file;
creating, based on the syntax, one or more groups of line specifications, wherein each line specification in a group includes matching terms or values specified by a user or both;
generating a new configuration for a first device which is associated with a pre-deployment state;
deploying the new configuration to the first device to obtain a post-deployment state;
obtaining one or more changed lines by determining a difference between the pre-deployment state and the post-deployment state;
storing information associated with the changed lines;
identifying, based on the created groups of line specifications and a set of criteria, other devices to which to deploy the new configuration;
ordering a first list of the other devices by ranking the other devices based on the criteria, which includes at least whether a respective changed line in a respective configuration for one of the other devices includes a first value for a term which is closer, based on a predetermined threshold, to a second value for a term of the pre-deployment state;
displaying, to a user on a display screen of a computing device, the ordered first list of the other devices;
selecting, by the user, one or more of the other devices to which to deploy the new configuration;
deploying the new configuration to the selected other devices;
validating the deployed new configuration for the selected other devices; and
displaying, to the user on the display screen, a second list which indicates whether the deployed new configuration for the selected other devices is successfully validated.
